(19) United States
(12) Patent Application Publication
(10) Pub. No.: US 2010/0080967 A1
(43) Pub. Date: Apr. 1, 2010

(54) Transparent conductive layered structure for a touch panel input device

(76) Inventors: Wun-Wei Hu, Tainan City (TW); Min-Wei Jheng, Tainan City (TW); Kuang-Rong Lee, Tainan City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 12/380,178

(22) Filed: Feb. 23, 2009

(30) Foreign Application Priority Data
Sep. 30, 2008 (TW) 097137466

(51) Int. Cl. B32B 5/16; B32B 15/08

(52) U.S. Cl. 428/203; 428/457; 428/332

(57) ABSTRACT

A transparent conductive layered structure for a touch panel input device includes: a substrate; and a layered conductor which includes a transparent first conductive layer formed on the substrate and including a film of conductive polymer, and a second conductive layer formed on the first conductive layer opposite to the substrate and including a conductive metal and/or metal compound. The second conductive layer has a conductivity larger than that of the first conductive layer.

### CROSS-REFERENCE TO RELATED APPLICATION

This application claims priority of Taiwanese application no. 097137466, filed on Sep. 30, 2008.

### BACKGROUND OF THE INVENTION

1. Field of the invention

This invention relates to a transparent conductive layered structure for a touch panel input device, more particularly to a transparent conductive layered structure including a second conductive layer that is formed on a first conductive layer and that has a conductivity larger than that of the first conductive layer.

2. Description of the related art

FIG. 1 shows a touch panel input device including a transparent conductive layered structure 1 that has a substrate 11 and a transparent conductive layer 12 made of indium tin oxide (ITO) and formed on the substrate 11, and a conductive glass 2 made of ITO and spaced apart from the transparent conductive layered structure 1 by a plurality of dot spacers 3. When a user presses the substrate 11, the transparent conductive layer 12 bends and electrically contacts the conductive glass 2.

Generally, the sensitivity of a touch panel is determined by the conductivity of the conductive layer 12. Since ITO is highly conductive, the transparent conductive layered structure 1 has sufficiently high sensitivity that can pass two important sensitivity tests for a touch panel. One of the tests is carried out by giving several taps on the touch panel. The other test is a draw test that is conducted by drawing on the touch panel.

Although the ITO transparent conductive layer 12 has good sensitivity sufficient for passing the aforesaid sensitivity tests, it is prone to rupture due to its poor flexural strength.

In order to improve flexural strength, conductive polymers have been used in the prior art in place of the ITO transparent conductive layer 12. However, due to the low conductivity of the conductive polymers, touch panel input devices employing the conductive polymer layer are unable to pass the draw test.

### SUMMARY OF THE INVENTION

Therefore, an object of the present invention is to provide a transparent conductive layered structure for a touch panel input device that can overcome the aforesaid drawback associated with the prior art.

According to one aspect of the present invention, a transparent conductive layered structure for a touch panel input device comprises: a substrate; and a layered conductor which includes a transparent first conductive layer formed on the substrate and including a film of conductive polymer, and a second conductive layer formed on the first conductive layer opposite to the substrate and including a conductive metal and/or metal compound. The second conductive layer has a conductivity larger than that of the first conductive layer.

According to another aspect of the invention, a touch panel input device comprises the aforesaid transparent conductive layered structure.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary schematic sectional view of a conventional touch panel input device;

FIG. 2 is a schematic view of the first preferred embodiment of a transparent conductive layered structure according to this invention;

FIG. 3 is a schematic view of the second preferred embodiment of the present invention;

FIG. 4 is a schematic view of the third preferred embodiment of this invention;

FIG. 5 is a schematic view of the fourth preferred embodiment of the transparent conductive layered structure according to this invention;

FIG. 6 is a schematic view of the fifth preferred embodiment of the transparent conductive layered structure according to this invention;

FIG. 7 is a schematic view of the sixth preferred embodiment of the present invention;

FIG. 8 shows a touch panel input device incorporating the transparent conductive layered structure according to this invention;

FIG. 9 is a schematic view of the seventh preferred embodiment of the present invention;

FIG. 10 is a schematic view of the eighth preferred embodiment of the transparent conductive layered structure according to this invention;

FIG. 11 is a schematic view of the ninth preferred embodiment of the transparent conductive layered structure according to this invention;

FIG. 12 is a schematic view of the tenth preferred embodiment of the transparent conductive layered structure according to this invention;

FIG. 13 is a schematic view of the eleventh preferred embodiment of the transparent conductive layered structure according to this invention;

FIG. 14 shows result of a touch panel input device that passed a sensitivity test; and

FIGS. 15 and 16 show results of a touch panel input device that failed the sensitivity test.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

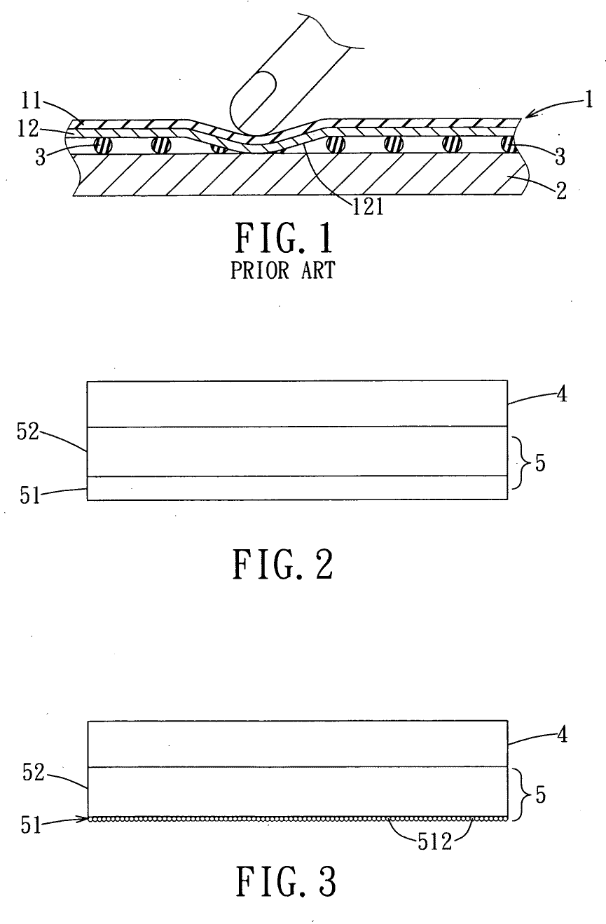

FIG. 2 illustrates the first preferred embodiment of a transparent conductive layered structure of a touch panel input device according to this invention.

The first preferred embodiment includes: a substrate 4; and a layered conductor 5 which includes a transparent first conductive layer 52 formed on the substrate 4 and made of a film of conductive polymer, and a second conductive layer 51 formed on the first conductive layer 52 opposite to the substrate 4 and made of a conductive metal and/or metal compound. The second conductive layer 51 has a conductivity larger than that of the first conductive layer 52.

In particular, the film of the conductive polymer in the first conductive layer 52 may be formed by applying to the substrate 4 a solution in which the conductive polymer is dispersed or dissolved. The conductive polymer is formed into the film when the solution is dried and hardened. Formation of the second conductive layer 51 may be conducted through dry coating processes, such as sputtering, vacuum evaporation, pulse laser evaporation, etc.

FIG. 3 illustrates the second preferred embodiment of the transparent conductive layered structure according to the present invention. The second preferred embodiment differs from the first embodiment in that, the second conductive layer 51 is a thin layer formed from the metal or the metal compound which is in the form of particulate particles 512, preferably nanoparticles 512. The thin layer of the second conductive layer 51 may be formed by applying a suspension of nanoparticles to the surface of the first conductive layer 52.

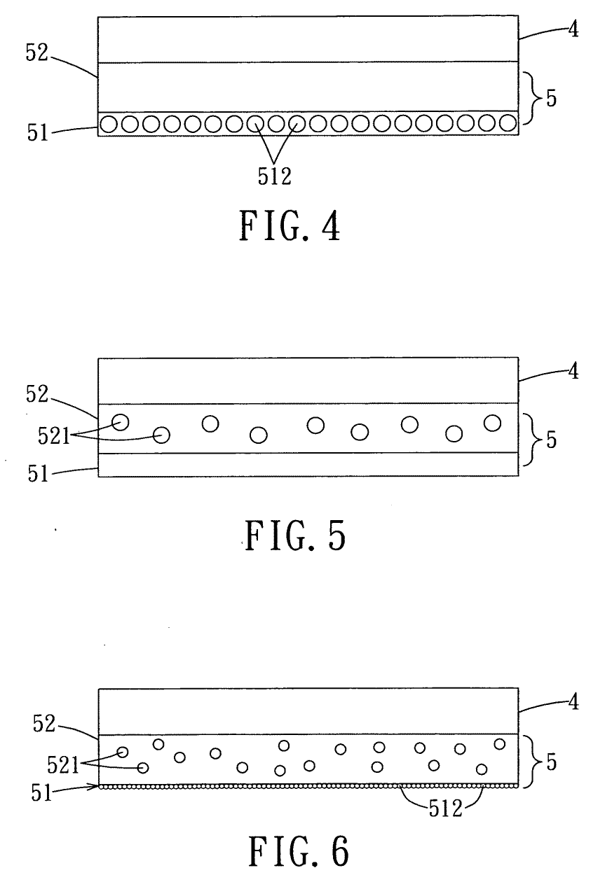

FIG. 4 illustrates the third preferred embodiment of the transparent conductive layered structure according to the present invention. The third preferred embodiment differs from the second embodiment in that, the second conductive layer 51 contains a conductive polymer in addition to the nanoparticles 512, and may be formed by applying to the first conductive layer 52 a liquid composition including the conductive polymer and the nanoparticles 512. Film forming property of the second conductive layer 51 is enhanced in the third preferred embodiment compared to the second preferred embodiment.

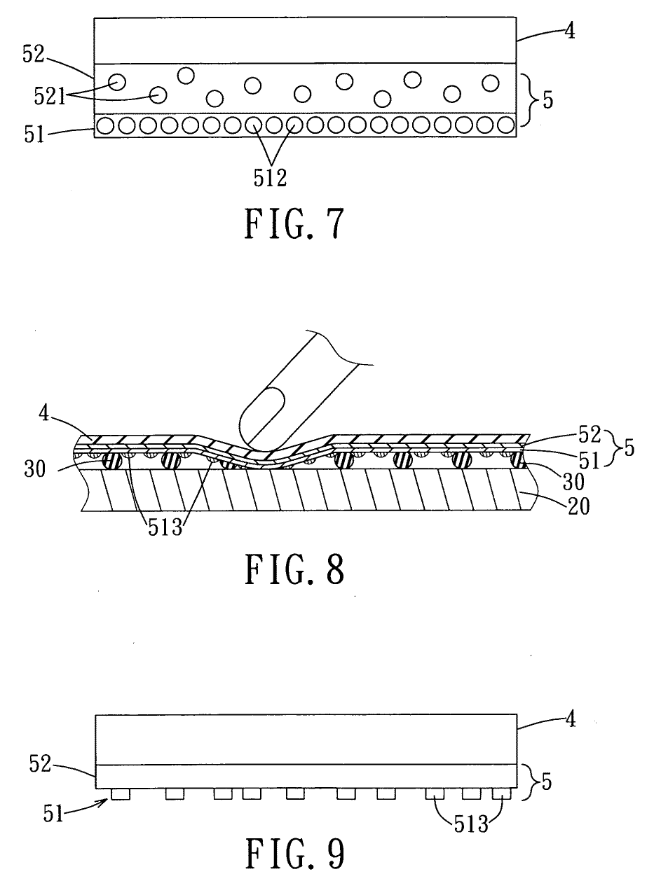

Referring to FIGS. 5, 6 and 7, there are shown fourth, fifth and sixth preferred embodiments of the present invention which differ respectively from the first, second and third preferred embodiments in that the first conductive layer 52 contains conductive particles 521. The presence of the conductive particles 521 can enhance conductivity of the first conductive layer 52. The conductive particles 521 may be the same as the nanoparticles 512 used in the second and third preferred embodiments.

Referring to FIG. 8, there is shown a touch panel input device which includes the transparent conductive layered structure according to the present invention. Spacers 30 are provided between the layered conductor 5 and a conductor film 20. The layered conductor 5 has protrusions 513 which will be described hereinafter. With the protrusions 513, the second conductive layer 51 can contact readily and effectively the conductor film 20 when the layered conductor 5 is pressed. The protrusions 513 can improve the sensitivity of the touch panel input device.

Referring to FIG. 9, the seventh preferred embodiment of the present invention differs from the first embodiment in that the first conductive layer 52 has the protrusions 513 protruding therefrom because the second conductive layer 51 is formed as dots or a screen web on the first conductive layer 52.

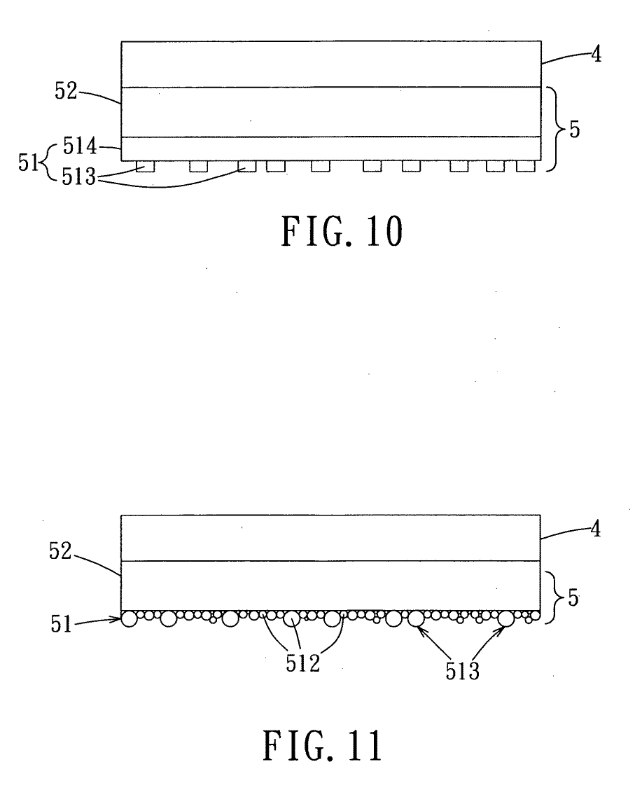

Referring to FIG. 10, the eighth preferred embodiment of the present invention differs from the seventh preferred embodiment in that the second conductive layer 51 has a film layer 514 and the protrusions 513 protruding from the film layer 514. The second conductive layer 51 may be formed using a dry coating or wet coating process. A mask may be used to form the protrusions 513.

Referring to FIG. 11, the ninth preferred embodiment of the present invention differs from the second preferred embodiment in that the nanoparticles 512 has a wide particle size distribution so that the first conductive layer 51 has an uneven surface attributed to the protrusions 513.

It is noted that, when the suspension of the nanoparticles 512 used in the second preferred embodiment has a low concentration, the nanoparticles 512 will be dispersed less densely, thereby forming the protrusions 513.

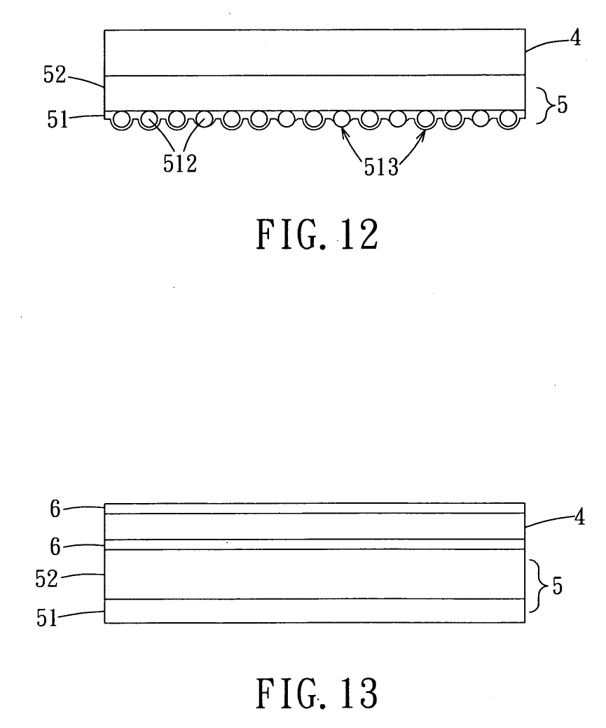

Referring to FIG. 12, the tenth preferred embodiment of the present invention differs from the third preferred embodiment in that the liquid composition used for the second conductive layer 51 contains a greater amount of the nanoparticles 512 compared to that used in the third preferred embodiment so that the surface of the second conductive layer 51 becomes uneven, thereby forming the protrusions 513. In this case, the protrusions 513 are formed from the nanoparticles 512 and the conductive polymer covering the nanoparticles 512.

It is worth mentioning that the first conductive layer 52 in the seventh to tenth preferred embodiments may contain conductive particles 521.

Like the conventionally used substrate, the substrate 4 used in the present invention may be provided with an additional layer 6 which may be a hard coat layer, an anti-glare layer, an anti-reflective layer, a water and gas impermeable layer, an anti-static layer, a high-refractive layer, a low-refractive layer, or any combination thereof. Referring to FIG. 13, the eleventh preferred embodiment of the present invention includes two additional layers 6 sandwiching the substrate 4.

The substrate 4 may be made from any suitable polymer, such as polyimide, polycarbonate, polyethylene terephthalate, polyethylene naphthalate, polymethyl methacrylate, polyacrylate, triacetate cellulose, cycloolefin polymer, cycloolefin copolymer or any combination thereof. Alternatively, the substrate 4 may be made of glass. When the thickness of the substrate 4 ranges from 25 μm to 300 μm, the substrate 4 can exhibit flexibility. In a preferred embodiment, the substrate 4 is made from polyethylene terephthalate, and has a thickness of 188 μm and a light transmittance of 90%.

For the second conductive layer 51, the height of the protrusions 513 should be smaller than that of the spacers 30 (FIG. 8) in order to avoid the problem that the layered conductor 5 contacts, before being pressed, the conductor film 20 causing signal misreading or even short circuits. Preferably, the protrusions 513 have a protruding height smaller than 5 μm.

Preferably, the second conductive layer 51 has a thickness of less than 10 μm, and more preferably, less than 5 μm. In the preferred embodiments, the thickness ranges from 1 nm to 4 μm.

It is noted that formation of the second conductive layer 51 having a thickness of less than 10 nm can be conducted through a dry coating technique. A larger thickness (more than 10 nm) for the second conductive layer 51 may be obtained using a wet coating technique.

Preferably, the transparent conductive layered structure of the present invention has a light transmittance greater than 70%, more preferably, greater than 75%, and most preferably, greater than 80%.

On the other hand, the entire layered conductor 5 preferably has a thickness ranging from 0.01 μm to 20 μm, more preferably, ranging from 0.05 μm to 10 μm, and most preferably, ranging from 0.1 μm to 5 μm.

Preferably, the nanoparticles 512 or the conductive particles 521 have a particle size ranging from 1 nm to 1000 nm, more preferably, from 5 nm to 500 nm, and most preferably, from 10 nm to 100 nm.

The conductivity of the second conductive layer 51 is preferably greater than 1 S/cm, and more preferably, greater than 100 S/cm.

The conductivity of the conductive metal or metal compound used in the first or second conductive layer 52, 51 should be greater than 1 S/cm or greater than 100 S/cm.

The conductive metal used in the invention may be selected from the group consisting of gold, silver, copper, iron, nickel, zinc, indium, tin, antimony, magnesium, cobalt, lead, platinum, titanium, tungsten, germanium, aluminum, and combinations thereof.

The conductive metal compound used in the invention may be selected from the group consisting of In₂O₃ (conductivity of about 10⁴ S/m), SnO₂ (conductivity of about 1.3×10³ S/m), ITO (conductivity ranging from 10⁴ to 10⁵ S/m), ZnO (conductivity of about 2×10³ S/m), ATO (antimony tin oxide, conductivity of about 10³ S/m), AZO (antimony zinc oxide, conductivity of about 10³ S/m), and combinations thereof In the preferred embodiments, ITO and/or AZO are used.

The conductivity of the first conductive layer 52 is preferably larger than 0.01 S/cm, and more preferably, larger than 0.1 S/cm.

The conductive polymer used in the first or second conductive layer 52, 51 may be a π-electron containing conjugated polymer whose conductivity is larger than 0.01 S/cm or larger than 0.1 S/cm. Examples of the conductive polymer are polypyrrole, polythiophene, polyaniline, poly(p-phenylene), poly(phenylene vinylene), poly(3,4-ethylenedioxythiophene) (PEDT), polystyrene sulfonate (PSS), and combinations thereof. In the preferred embodiments, a mixture of poly(3,4-ethylenedioxythiophene) and polystyrene sulfonate (PEDT/PSS), which has a conductivity ranging from 0.1 to 1 S/cm, is used.

Any suitable solvent may be used for preparing the solution or dispersion (liquid composition) of the conductive polymer. Examples of the solvents include isopropanol (IPA), methyl ethyl ketone (MEK), methanol, ethanol, methyl isobutyl ketone (MIBK), water, and combinations thereof. In the preferred embodiments, IPA is used.

The solution or dispersion (liquid composition) of the conductive polymer used in the present invention may further include additives, such as an adhesive to enhance adhesion between layers, a conductivity-enhancing agent, a surfactant, etc. The adhesive may be selected from polyurethane dispersion, polyester dispersion, polyvinyl alcohol, polyvinylidenechloride dispersion, silane, and combinations thereof. The conductivity-enhancing agent may be selected from dimethylsulfoxide (DMSO), N-methylpyrrolidone (NMP), N,N-dimethylformamide, N,N-dimethylacetamide, ethylene glycol, glycerine, sorbitol, etc.

When the conductive polymer is mixed with the nanoparticles 512 or the conductive particles 521, the weight ratio of the conductive polymer to the nanoparticles 512 or the conductive particles 521 may range from 0.01 to 100, more preferably, range from 0.1-50, and most preferably, range from 0.25-25.

In order to form the protrusions 513, the weight ratio of the nanoparticles 512 to the conductive polymer is preferably larger than 0.2, and more preferably ranges from 0.25 to 100.

The layered conductor 5 may be provided with a surface resistance less than 2000 ohms/square, preferably, less than 1500 ohms/square, more preferably, less than 1000 ohms/square, and most preferably, ranging from 200 to 800 ohms/square.

The merits of the transparent conductive layered structure for a touch panel input device according to this invention will become apparent with reference to the following Examples.

### EXAMPLES

### Examples E1-E6 and Comparative Examples CE1-CE5

### Materials and Equipment

(1) Substrate: PET substrate, A4300, produced by TOYOBO.

(2) Conductive polymer dispersion: PEDT/PSS, solid content 2 wt %, produced by H.C. Starck, Item No. Clevios P HCV 4, polymer conductivity 0.3 S/cm.

(3) Conductive nanoparticle metal compound: AZO dispersion manufactured by Nissan Chemical, solid content 40 wt %, particle size distribution ranging from 15 nm to 100 nm.

(4) Solvent: isopropanol (IPA), produced by Acros Organics.

(5) Conductivity-enhancing agent: N-methyl-2-pyrrolidinone (NMP), produced by Acros Organics.

(6) Surfactant: Dynol 604, produced by Air Products.

(7) Adhesive: Silquest A187, produced by Momentive.

(8) Coating rod: No. 4 and No. 14 produced by RDS.

(9) ITO target: In₂O₃—SnO₂ (90-10 wt %), produced by Mitsui.

### Tests

(1) Light transmittance test: a light with a wavelength of 550 nm passes through a transparent conductive layered structure, and then a ratio of the transmitted light to the incident light is measured using a spectrophotometer CM-3600D, produced by KONICA MINOTA.

(2) Surface resistance test: it is measured using a resistance tester (produced by Mitsubishi Chemical Laresta-EP) and a four point probe. A standard value for a transparent layered conductor ranges from 200 ohms/square to 800 ohms/square.

(3) Sensitivity tests

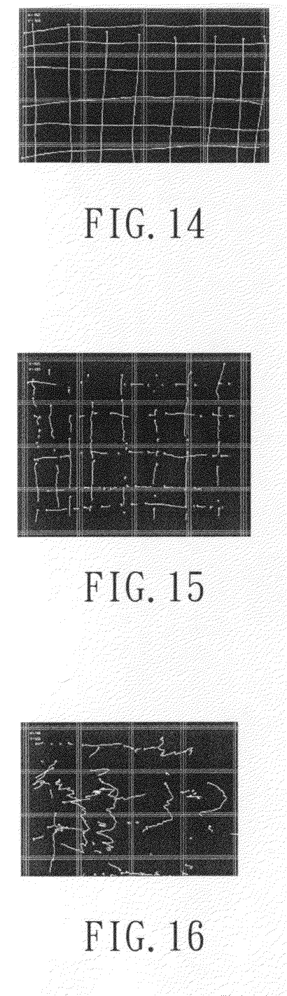

A transparent conductive layered structure of a commercial touch panel input device (AbonTouch, 15 inches) is replaced by the Examples of the invention and the Comparative Examples, and the touch panel input device is connected to a computer. During testing, Lines or patterns are drawn on the touch panel input device with a touch pen. Thereafter, the results shown on a display of the computer are observed to check whether or not the lines or patterns as drawn are completely inputted via the touch panel input device. Symbol ‘◯’ indicates that the lines or patterns as drawn are completely inputted via the touch panel input device (see FIG. 14) and that the touch panel input device has passed the sensitivity test. Symbol ‘Δ’ indicates that most parts of the lines or patterns as drawn are inputted via the touch panel input device (see FIG. 15). Symbol ‘×’ indicates that the lines or patterns as drawn are inputted only in bits (see FIG. 16). The symbols ‘Δ’ and ‘×’ indicate that the touch panel input device failed the sensitivity test.

### Example E1

A conductive polymer formulation shown in Table 1 was prepared and then coated on a PET substrate using No. 14 coating rod. After a drying treatment at 120° C. for 5 min, a first conductive layer was formed on the PET substrate. Subsequently, an ITO film having a thickness of 1 nm was formed on the first conductive layer by sputtering an ITO target. A transparent conductive layered structure thus formed includes the first and second conductive layers.

TABLE 1

| | Con- | | | Con- | | |
|---|---|---|---|---|---|---|
| | ductive | | | ductivity - | | |
| | Polymer | | | enhancing | | Total |
| | dispersion | Solvent | Surfactant | agent | Adhesive | amount |
| E1 | 50 wt % | 45 wt % | 1 wt % | 3 wt % | 1 wt % | 100 wt % |

### Examples E2 and E3

The first conductive layers of Examples E2 and E3 were formed following the procedure of Example E1. However, the second conductive layer was formed using the AZO dispersion that was diluted 100 fold with the solvent IPA until the solid content is lowered to 0.4% in Example E2. The AZO dispersion was not diluted in Example E3. The AZO dispersion was coated on the first conductive layer using No. 4 coating rod. After a drying treatment, the second conductive layers of Examples E2 and E3 were obtained.

It was observed that amount of the AZO particles of Example E3 was greater than that of Example E2.

### Examples E4 and E5

Each of the first conductive layers of Examples E4 and E5 was formed following the procedure of Example E1. However, the second conductive layer was formed using No. 4 coating rod and using the formulations shown in Table 2. Since the second conductive layers of Examples E4 and E5 contained the conductive polymer, the film forming properties thereof were better than those of Examples E2 and E3.

Since the ratio of AZO particles to the conductive polymer of Example E5 was greater than that of Example E4, it is presumed that the second conductive polymer of Example E5 has a plurality of protrusions thereon.

TABLE 2

| | | | | | | | | Ratio of |
|---|---|---|---|---|---|---|---|---|
| | | | | | | | Ratio of | particles |
| | Conductive | | | | Conductivity - | | conductive | to |
| | Polymer | AZO | | | enhancing | | polymer to | conductive |
| | dispersion | particles | Solvent | Surfactant | agent | Adhesive | particles | polymer |
| E4 | 50 wt % | 0.5 wt % | 44.5 wt % | 1 wt % | 3 wt % | 1 wt % | 5 | 0.2 |
| E5 | 50 wt % | 10 wt % | 35 wt % | 1 wt % | 3 wt % | 1 wt % | 0.25 | 4 |

### Example E6

Example E6 was proceeded following the procedure of Examples E4 and E5 and using the formulations of Examples E4 and E5. The first conductive layer of Example E6 was formed from the formulation of Example E4, whereas the second conductive layer of Example E6 was formed from the formulation of Example E5. Because the ratio of the AZO particles to the conductive polymer is higher in the second conductive layer than in the first conductive layer, the conductivity of the second conductive layer is higher than that of the first conductive layer, and protrusions will be on the second conductive layer.

It is noted that the thickness of the second conductive layers of Examples E1-E5 ranges from 1 nm-4 μm.

### Comparative Example CE1

A transparent conductive layered structure of Comparative Example CE1 was obtained from a commercial touch panel input device (AbonTouch 15″), and includes a substrate and an ITO film formed on the substrate.

### Comparative Example CE2

The transparent conductive layered structure of Comparative Example CE2 was made by applying to a substrate a conductive polymer (PEDT/PSS) dispersion corresponding to a composition disclosed in Example E1 of U.S. Pat. No. 7,332,107. The surface resistance of the conductive polymer meets the standard specification (i.e., 200 ohms/square to 800 ohms/square).

### Comparative Example CE3

The transparent conductive layered structure of Comparative Example CE3 was made by applying to a substrate a conductive polymer (PEDT/PSS) dispersion corresponding to a composition disclosed in Example E1 of WO 2007/037292. The surface resistance of the conductive polymer meets the standard specification (i.e., 200 ohms/square to 800 ohms/square).

### Comparative Examples CE4 and CE5

The transparent conductive layered structures of Comparative Examples CE4 and CE5 were substantially similar to that of Comparative Example CE1, except that each of Comparative Examples CE4 and CE5 had a conductive polymer layer in addition to the ITO film on the substrate. The conductive polymer layers of Comparative Examples CE4 and CE5 were formed using No. 4 coating rod and No. 14 coating rod, respectively, and thus had different thickness.

### Testing:

Each of the transparent conductive layered structures of Examples E1-E6 and Comparative Examples CE1-CE5 was installed in a touch panel input device and connected to a computer to undergo tests. Test results are shown in Table 3.

TABLE 3

| | Light | |
|---|---|---|
| | transmittance | |
| | (%) | Sensitivity |
| E1 | 85.3 | ◯ |
| E2 | 84.8 | ◯ |
| E3 | 84.0 | ◯ |
| E4 | 82.5 | ◯ |
| E5 | 81.3 | ◯ |
| E6 | 80.1 | ◯ |
| CE1 | 87.4 | ◯ |
| CE2 | 85.1 | X |
| CE3 | 84.4 | X |
| CE4 | 85.5 | Δ |
| CE5 | 84.8 | X |

The results show that Examples E1 to E6 and Comparative Example CE1 passed the sensitivity test. However, Example E1 is more durable than Comparative Example CE1 because Example E1 has the conductive polymer layer in addition to the ITO film. Comparative Example CE1 becomes useless when the ITO film thereof ruptures. In Example E1, even when the ITO film ruptures, Example E1 can still work because the conductive polymer layer can take over the function of signal transmission and current conduction.

The results further show that the sensitivity of Comparative Examples CE4 or CE5, in which the order of the ITO film and the conductive polymer layer is reversed compared to Example E1, are inferior than that of Examples E1-E6.

By forming the second conductive layer, which has a higher conductivity, on the first conductive layer, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A transparent conductive layered structure for a touch panel input device, comprising:
a substrate; and
a layered conductor which includes a transparent first conductive layer formed on said substrate and including a film of conductive polymer, and a second conductive layer formed on said first conductive layer opposite to said substrate and including a conductive metal and/or metal compound;
wherein said second conductive layer has a conductivity larger than that of said first conductive layer.

2. The transparent conductive layered structure of claim 1, wherein said second conductive layer has a conductivity larger than 1 S/cm.

3. The transparent conductive layered structure of claim 2, wherein said second conductive layer has a conductivity larger than 100 S/cm.

4. The transparent conductive layered structure of claim 1, wherein said conductive metal and/or metal compound is formed as a thin layer.

5. The transparent conductive layered structure of claim 4, wherein said thin layer of said conductive metal and/or metal compound has a plurality of protrusions,

6. The transparent conductive layered structure of claim 5, wherein each of said protrusions protrudes from a surface of said thin layer with a protruding height smaller than 5 μm.

7. The transparent conductive layered structure of claim 5, wherein said conductive metal and/or metal compound is in the form of particulate particles having a particle size ranging from 1 nm to 1000 nm.

8. The transparent conductive layered structure of claim 7, wherein said second conductive layer further includes a conductive polymer, said particulate particles being dispersed in said conductive polymer of said second conductive polymer.

9. The transparent conductive layered structure of claim 8, wherein the weight ratio of said particulate particles to said conductive polymer in said second conductive layer ranges from 0.01 to 100.

10. The transparent conductive layered structure of claim 9, wherein the weight ratio of said particulate particles to said conductive polymer in said second conductive layer ranges from 0.25 to 100.

11. The transparent conductive layered structure of claim 1, wherein said conductive metal is selected from the group consisting of gold, silver, copper, iron, nickel, zinc, indium, tin, antimony, magnesium, cobalt, lead, platinum, titanium, tungsten, germanium, aluminum, and combinations thereof.

12. The transparent conductive layered structure of claim 1, wherein said conductive metal compound is selected from the group consisting of In₂O₃, SnO₂, ITO, ZnO, ATO, AZO, and combinations thereof.

13. The transparent conductive layered structure of claim 1, wherein said conductive polymer of said first conductive layer has a conductivity greater than 0.01 S/cm.

14. The transparent conductive layered structure of claim 8, wherein said conductive polymer of said first or second conductive layer is selected from the group consisting of polypyrrole, polythiophene, polyaniline, poly(p-phenylene), poly(phenyl vinylene), poly(3,4-ethylenedioxythiophene), polystyrene sulfonate, and combinations thereof.

15. The transparent conductive layered structure of claim 1, wherein said second conductive layer has a thickness ranging from 1 nm to 4 μm.

16. The transparent conductive layered structure of claim 1, wherein said layered conductor has a thickness ranging from 0.01 μm to 20 μm.

17. The transparent conductive layered structure of claim 1, wherein said layered conductor has an average sheet resistance less than 2000 ohms/square.

18. The transparent conductive layered structure of claim 1, wherein said first conductive layer further includes conductive particles dispersed in said conductive polymer of said first conductive layer.

19. The transparent conductive layered structure of claim 1, wherein said transparent conductive layered structure has a light transmittance greater than 70%.

20. A touch panel input device comprising a transparent conductive layered structure as claimed in claim 1.
